(19) United States
(12) Patent Application Publication
(10) Pub. No.: US 2014/0361624 A1
(43) Pub. Date: Dec. 11, 2014

(54) APPARATUS AND METHODS FOR CONTROL OF LOAD POWER QUALITY IN UNINTERRUPTIBLE POWER SYSTEMS

(71) Applicant: Active Power, Inc., Austin, TX (US)

(72) Inventors: Terry Ault, Austin, TX (US); Ron Landis, Austin, TX (US); Bernardo Mendez Arista, Austin, TX (US); Ake Almgren, Austin, TX (US)

(21) Appl. No.: 14/300,895

(22) Filed: Jun. 10, 2014

Related U.S. Application Data
(60) Provisional application No. 61/833,288, filed on Jun. 10, 2013.

(51) Int. Cl. H02J 3/00

(52) U.S. Cl. CPC H02J 3/005
USPC 307/65

(57) ABSTRACT

Systems and methods for supplying power to a load include a static switch between a primary power source and a power conditioner associated with a secondary power source, and maintenance switches between the primary and secondary power sources and a load. A controller is operable to actuate the switches. The static switch is operable to conduct power from the primary power source to a capacitor associated with the power conditioner. Current supplied from the primary power source includes portions at a fundamental frequency and a harmonic frequency. The secondary power source or the capacitor, or both, can be used to supply reactive power having a current equal and opposite that of the harmonic portion such that substantially all of the current provided to the load by the primary power source is at the fundamental frequency.

### CROSS-REFERENCE TO RELATED APPLICATIONS

The present application claims priority to the U.S. Provisional Application for Patent having the Application Ser. No. 61/833,288, filed Jun. 10, 2013, which is incorporated by reference herein in its entirety.

### FIELD OF THE INVENTION

Embodiments usable within the scope of the present disclosure relate, generally, to uninterruptible power systems and supplies, and more specifically, to devices, systems, and methods for controlling the quality of power delivered by an interruptible power system, e.g., during normal and fault conditions.

### BACKGROUND

A basic function of an uninterruptible power system (“UPS”) is to ensure continued delivery of power to loads under a variety of primary power fault conditions and disturbances. With reference to the block diagram of FIG. 1, for example, a UPS 100 may comprise a first input 102 for receiving energy from a primary power source 103, such as an AC utility source delivered from a power grid; a second input 104 for receiving energy from a second (e.g., backup) power source 105, such as a battery or an AC generator; and an output 106 for delivering energy to loads 112. In some embodiments the second power source 105 may be included within the UPS 100. Under “normal” operating conditions (e.g., conditions under which the primary power source is within defined, acceptable, operating limits of voltage and frequency), power for loads 112 may be derived from the primary power source 103. Otherwise, power may be derived from the backup power source 105.

Increasing use of alternative energy sources is contributing to degradation in the quality of the power delivered by the AC power grid. Compared to conventional large-scale AC power generation facilities, alternative power sources are more likely to exhibit power interruptions and power quality issues, thereby contributing, in aggregate, to a variety of power line disturbances, such as, e.g., power sags, power surges, undervoltage or overvoltage conditions, transients associated with source switching on the utility line, utility line noise, frequency variations, harmonic distortion, line brownouts and line dropouts. Contemporary loads, however, and particularly electronic loads, may require an uninterrupted flow of high quality AC power. Regulatory requirements may also limit the harmonic content and/or power factor of equipment connected to utility lines. The extent to which a UPS can reduce or eliminate the effects of line disturbances on the quality of the AC power which it delivers, as well as control the harmonic content and power factor reflected back to the utility source, may be important factors in evaluation of UPS performance.

Various UPS configurations are known. One configuration, referred to herein as a double-conversion UPS, is illustrated in the block diagram of FIG. 2. The double-conversion UPS 100A may, e.g., receive primary power from a three-phase AC utility source 103 and receive backup power from a bank of storage batteries 105A. A rectifier-charger circuit 114 converts the three-phase AC input into DC; an inverter circuit 116 converts the DC back into a three-phase AC output for delivery to loads 112. A controller 118 may monitor various system parameters and control the rectifier-charger circuit 114 and the inverter circuit 116 as a means of providing uninterrupted power flow to the loads 112; the controller may also control the inverter 116 to control the quality of the power delivered to the loads as a means of reducing or eliminating the effects of line disturbances and/or controlling power factor reflected back to the utility line.

Another UPS configuration, referred to herein as a line-interactive UPS, is shown in FIG. 3. The line interactive UPS 100B may, e.g., receive primary power from a three-phase AC utility source 103 and receive backup power from a backup AC generator 105B. The backup AC generator may, e.g., be a flywheel motor/generator of the kind described in U.S. Pat. No. 5,932,935, which is incorporated herein in its entirety by reference. Each phase of the line-interactive UPS 100B can include a static AC switch 122 and a backup power conditioner 130. With reference to FIG. 4, a static AC switch 122 can include a pair of back-to-back SCRs 161, 162. The backup power conditioner can include a flywheel converter 128, a storage capacitor 126, a utility converter 124 and an output filter (indicated by inductor 134). A controller 120 monitors the various inputs and outputs and controls the static AC switch 122 and the backup power conditioner 130 to provide uninterrupted power flow to the loads 112 and compensate for line disturbances. Operation of a line-interactive converter is described in detail in Operation and Performance of a Flywheel-Based Uninterruptible Power Supply (UPS) System, White Paper #108, published by Active Power Inc., Austin, Tex., 78758, USA (found at http://www.activepower.com/documents/white_papers/), which is incorporated by reference herein in its entirety. Under “normal” operating conditions, the static AC switch 122 is ON and three-phase power is delivered from the AC utility source 103 to the loads via the output three-phase bus 136; the controller 120 may also regulate the magnitude of the output three-phase bus voltage by controlling the flow of reactive power between the power conditioner 130 and the bus 136.

Other known UPS topologies include, but are not limited to, Delta Conversion UPS, Rotary UPS and Hybrid UPS. Known backup energy sources include, but are not limited to, batteries, flywheel motor-generators, compressed air, fuel cells and fossil fuel powered motor-generator sets.

As shown in FIGS. 2 and 3, a UPS can include a bypass circuit 140, which can include, e.g., a static AC switch 122 such as the type shown in FIG. 4. When enabled, the bypass circuit 140 provides an essentially direct connection between the primary power source and the loads.

Conversion efficiency during normal operation is a recognized UPS performance factor, because higher conversion efficiency translates into reduced power loss and lower utility costs. Because the double-conversion UPS configuration processes utility power in each of two cascaded stages, its operating efficiency under normal operating conditions may be lower when compared, e.g., to a line interactive UPS, in which normal power flow is through a static AC switch. To improve normal operating efficiency, a double-conversion UPS may, under normal operating conditions, enable its bypass circuit 140, thereby allowing power to flow directly from the AC utility source 103 to the loads 112 and avoiding some of the losses associated with cascade power processing. This “eco-mode” of operation may improve normal conversion efficiency to a level comparable to the efficiency of a line-interactive converter; in doing so, however, some or all of the advantages provided by the double-conversion topology may be lost.

### BRIEF DESCRIPTION OF THE DRAWINGS

FIG. 1 shows a block diagram of an uninterruptible power system (“UPS”).

FIG. 2 shows a block diagram of a double-conversion UPS.

FIG. 3 shows a block diagram of a line-interactive UPS.

FIG. 4 shows a partial schematic of a static AC switch.

FIG. 5 shows an embodiment of a UPS usable within the scope of the present disclosure.

FIG. 6 shows a secondary source comprising an ultracapacitor.

FIG. 7 shows a secondary source comprising a flywheel motor/generator and a battery.

FIG. 8 shows a secondary source comprising an ultracapacitor and a battery.

FIG. 9 shows a secondary source comprising two or more energy sources.

FIG. 10 shows an embodiment of a UPS usable within the scope of the present disclosure.

FIG. 11 shows a partial schematic of an embodiment of a UPS usable within the scope of the present disclosure comprising a line inductor.

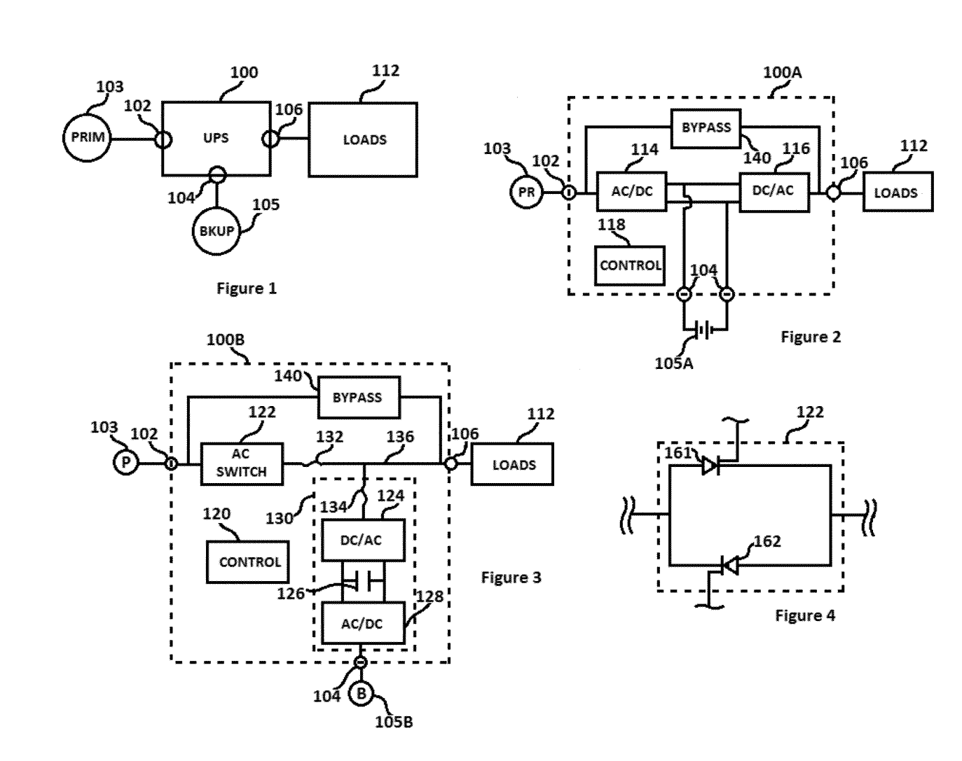

Like reference numbers in the various drawings indicate like elements.

### DETAILED DESCRIPTION

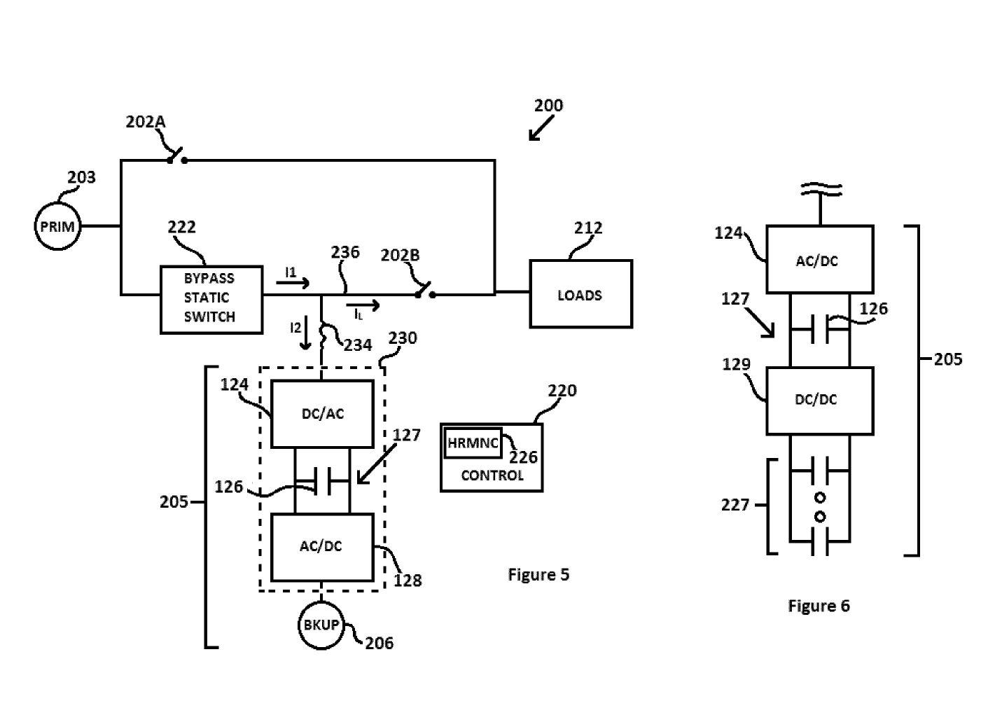

FIG. 5 depicts an embodiment of a UPS 200 usable within the scope of the present disclosure. The UPS 200 may, e.g., receive primary power from a primary AC power source 203 (e.g., a three-phase AC utility source; an AC generator; a fuel cell; and/or a wind turbine) and receive backup power from one or more secondary sources. One exemplary type of secondary source 205, shown in FIG. 5, can include a backup AC motor/generator 206, such as a flywheel motor/generator of the kind described in U.S. Pat. No. 5,932,935, incorporated by reference above, and a backup power conditioner 230. In an embodiment, the backup power conditioner can include an AC-to-DC flywheel converter 128, a DC bus 127, a DC storage capacitor 126 connected across the bus, and a DC-to-AC utility converter 124. The UPS 200 can include a bypass static switch 222, a first maintenance switch 202A and a second maintenance switch 202B. In an embodiment, the bypass static switch 222 can be of the type shown in FIG. 4. The maintenance bypass switches can include contactors and/or static switches, such as the type shown in FIG. 4. A controller 220 can be used to monitor system conditions (e.g., voltages, currents, frequency) and control the static AC switch 222, the maintenance switches 202A, 202B, the backup power conditioner 230 and/or the backup AC motor/generator 205, to control the flow of energy between and among the primary power source 203, the secondary source 205 and system loads 212, in order to provide an uninterrupted flow of high quality power to the loads 212. In various embodiments, monitoring and power conversion can be performed at frequencies (e.g. 6 KHz, 50 KHz) that are much higher than the nominal frequency of the utility source 203 (e.g., 50 Hz, 60 Hz), enabling the system to detect and respond to disturbances within a fraction of a line cycle. A line filter (indicated by inductor 234) can provide smoothing of the switched waveform delivered by backup conditioner 230. In an embodiment, the controller 220 can include a Harmonic Controller 226, discussed in more detail below.

Startup of the system 200 can be accomplished by closing maintenance bypass switch 202A, while the second maintenance switch 202B is open, thereby connecting the primary AC source 203 to, and disconnecting the bypass static switch 222 and the power conditioner 230 from, the loads 212. Controller 220 phase-controls the bypass static switch 222, and controls the backup power conditioner 230 and the motor/generator 205, to control a transfer of energy from the primary AC source 203 to the motor/generator 206. When the motor/generator stores sufficient energy, and the storage capacitor 126 is charged to a pre-determined nominal DC voltage, the controller turns the bypass static switch 222 fully ON. Subsequently, the controller turns the second maintenance switch 202B ON and the first maintenance switch 202A OFF in an overlapped, controlled, transfer, thereby connecting both the bypass static switch 222 and the output of the backup power conditioner 230 to the loads 212 via three-phase bus 236.

Under normal operating conditions, the static AC switch 222 is ON and the primary AC source 203 is effectively connected in parallel with the secondary source 205. Current delivered by the primary AC source, I1, would thereby be the sum of the current delivered to the secondary source, I2, and the current delivered to the load, I_{L}:

I1=I2+I_{L} (1)

In a typical installation, the current drawn by the load will not be a pure sinusoid at the fundamental frequency. Rather, the load current I_{L} may be composed of two components:

I_{L}=I_{f}+Iₕ (2)

where I_{f} is a component at the fundamental frequency, f, of the power source 203 and Iₕ is the sum of all of the components at harmonics of the fundamental frequency.

The harmonic controller 226 can be configured to control the harmonic content of the power delivered from the primary AC power source 203. In one example, the controller 220 may be configured to control the secondary source 205 so that I2=−Iₕ, thereby causing I1 to equal I_{f} and eliminating harmonic components from the primary source current I1. In this configuration, the secondary source 205 can supply all of the reactive harmonic currents Iₕ and the primary power source 203 can deliver all of the real and reactive load current at the fundamental frequency. The harmonic controller 226 may alternatively be configured to perform power factor correction: i.e., control the secondary source 205 to deliver both the reactive power at the fundamental frequency and the reactive power associated with the harmonics. For such a configuration, the secondary source could supply all of the reactive load current and the primary power source would only deliver the real power required by the load. In each configuration described above, the secondary source 205 delivers reactive power only.

In an embodiment, under normal operating conditions the bus capacitor 126 can supply substantially all of the reactive load current as well as transient currents that do not cause the DC bus 127 voltage to decline below a pre-determined level. The flywheel can be controlled to supply power that cannot be supplied by the capacitor (e.g., during abnormal conditions), up to the total real and reactive power required by the loads 212.

Another configuration of a secondary source, illustrated in FIG. 6, can include a bank of ultracapacitors 227, a DC-DC converter 129 (e.g., a boost converter), a bus capacitor 126, and a DC-to-AC utility converter 124. The ultracapacitors may be configured to store energy comparable to the energy stored in a flywheel (e.g. sufficient energy to operate loads 212 for a period of time, such as several minutes). Under normal operating conditions, the bus capacitor 126 can supply substantially all of the reactive load current as well as transient currents that do not cause the bus voltage to decline below a pre-determined level. Under abnormal conditions, the ultracapacitors can supply power that cannot be supplied by the bus capacitor, up to the total real and reactive power required by the loads 212.

Conventional systems may include a bank of batteries (e.g., storage batteries 105A, shown in FIG. 2) to provide backup power and to supply reactive and transient currents. Battery lifetime, however, is diminished by exposure to transient currents and discharge events. This is not the case for the secondary sources shown in FIGS. 5 and 6. Use of a flywheel and bus capacitor, and/or of the ultracapacitor and bus capacitor, may therefore provide for improved system reliability and reduced system maintenance.

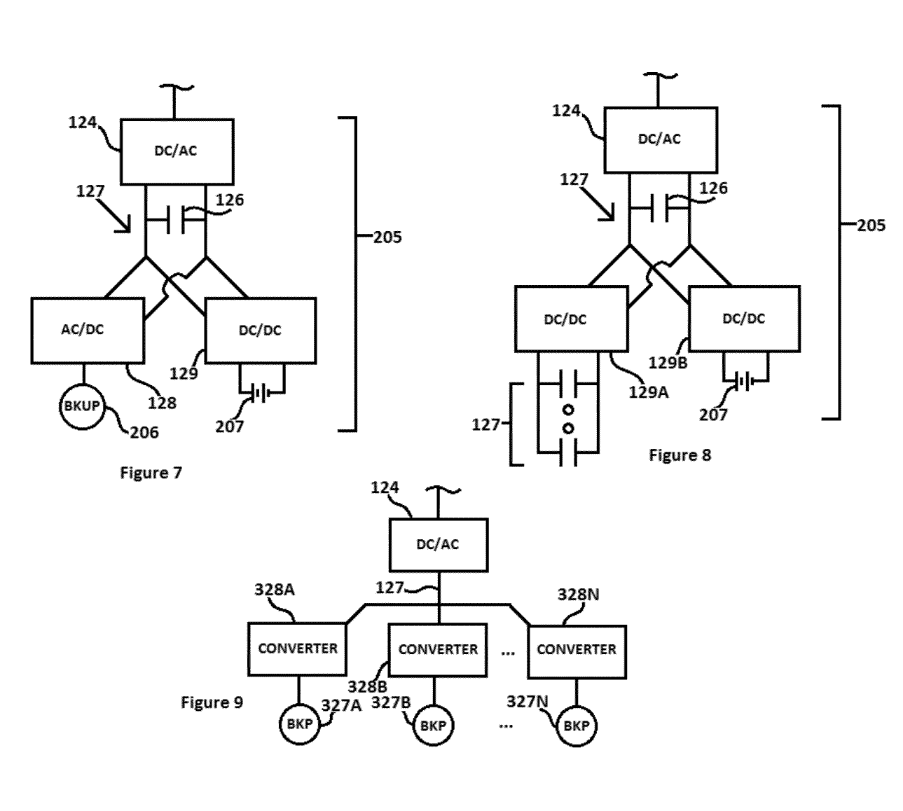

FIGS. 7 and 8 depict embodiments of secondary power sources usable within the scope of the present disclosure. In FIG. 7, the depicted system includes an AC motor/generator 206, such as a flywheel motor/generator of the kind described in U.S. Pat. No. 5,932,935, incorporated by reference above, and a battery bank 207. Power from the flywheel motor/generator 206 can be delivered to the DC bus 127 by means of AC-DC flywheel converter 128; power from the battery bank 207 can be delivered to the DC bus by means of DC-DC converter 129.

In FIG. 8, the depicted system includes a bank of ultracapactors 127 and a battery bank 207. Power from the ultracapacitor bank can be delivered to the DC bus 127 by means of DC-DC converter 129A; power from the battery bank 207 can be delivered to the DC bus by DC-DC converter 129B. Under normal operating conditions the bus capacitor 126 can supply substantially all of the reactive load current as well as transient currents that do not cause the bus voltage to decline below a pre-determined level. The flywheel motor/generator 206 (FIG. 7) or the ultracapacitor 127 (FIG. 8) may be controlled to supply power that cannot be supplied by the bus capacitor (e.g., during abnormal conditions), up to the total real and reactive power required by the loads 212. When the flywheel or ultracapacitor can no longer supply the power demanded by the load, the battery bank 207 can be controlled to supply load power, up to the total real and reactive power required by the loads 212. The secondary sources of FIGS. 7 and 8 may be configured so that relatively frequent short-term disturbances are managed by the combination of the bus capacitor and the flywheel or ultracapacitor, while the battery bank 207 is only used to deliver power in the event of a fault in the AC utility source 203 that exceeds the duration for which the flywheel and/or ultracapacitor is able to supply backup power. By using the batteries in this manner, backup time may be extended and battery life improved relative to systems in which the batteries are the principal power conditioning source. While FIGS. 7 and 8 depict discrete embodiments in which a flywheel and/or ultracapacitor are used as secondary power sources, it should be understood that in various embodiments, other types of secondary power sources could be used, and in still other embodiments, multiple secondary power sources could be used.

FIG. 9 depicts an embodiment of a secondary power source 205 that includes two or more forms of energy storage 327A, 327B . . . 327N, with corresponding converters 328A, 328B . . . 328N, connected to a common DC bus 127. The bus can include a storage capacitor 126, as previously described (not shown in FIG. 9). The energy storages 327A, 327B . . . 327N can be selected to provide a desired combination of response speed, backup time and reliability characteristics. For example, a secondary power source 205 could include a first energy source 327A capable of handling frequent charge-discharge cycles (e.g., a flywheel AC generator and/or an ultracapacitor) and a second energy source 328B with relatively high energy density and/or economy for managing longer duration faults in the primary AC source (e.g., lead-acid batteries, lithium-ion batteries, fuel cells, and/or fossil fuel or compressed air electrical generators).

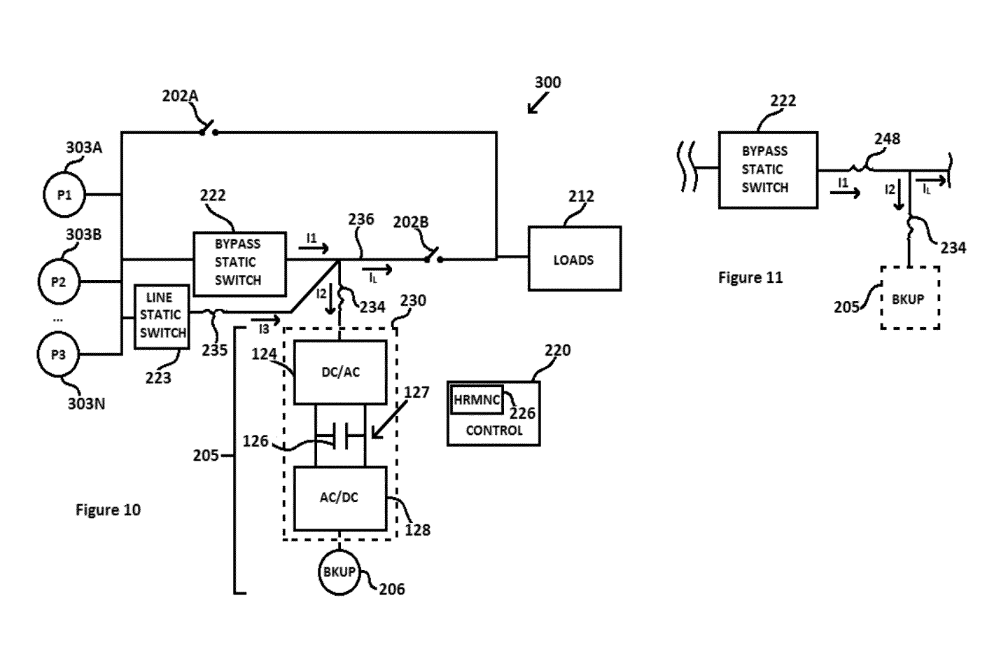

In the system depicted in FIG. 5, transferring load power from the secondary source 205 back to the primary source 203 can be accomplished by turning on bypass static switch 222, thereby exposing the primary AC source to a potentially large step change in load. Some primary AC sources (e.g., a motor-generator set) may not be able to supply a significant step in load power. FIG. 10 shows an embodiment of a system 300 that is configured to enable a gradual transition from the secondary source 205 to a primary AC source 303. As illustrated in FIG. 10, the primary source can include one or more types of AC sources 303A, 303B . . . 303N, such as, e.g., the AC grid, a motor generator set, a fuel cell, a wind turbine, etc.

In comparison to the system 200 of FIG. 5, the system 300 of FIG. 10 includes a line static switch 223 and a line inductor 235. The line static switch 223, which in an embodiment, may be configured as shown in FIG. 4, can be phase controlled by controller 220. In the system of FIG. 10, controller 220 controls the transfer of load from the secondary source 205 to the primary AC source 303 by phase controlling the line static switch 223 to gradually increase the AC current I3, while simultaneously controlling the secondary source to provide a corresponding gradual reduction in the current supplied by the secondary source 205. Controlling current in this manner can enable maintenance of the power quality and total power delivery to the loads 212, and the transfer of load to the primary AC source 303 in a manner that is within the capability of the source. Although secondary source 205 is shown in FIG. 10 to be identical to the secondary source 205 of FIG. 5, it is understood that it any type of secondary source, as described above, can be included in any of the depicted systems.

In various embodiments, some or all of the functional characteristics of a controller may be configured to be programmable by a user, thereby enabling a user to match system operating characteristics to a particular load or set of loads. A user may, for example, program the system to perform power factor correction only when the controller determines that load power factor is a predetermined value (e.g., load power factor is below 0.97). When power factor correction is required, the secondary source can be controlled to supply reactive currents, with corresponding power losses owing to flow of reactive currents in non-ideal circuit elements. When power factor correction is not required, however, the secondary source can be controlled to be in a standby mode, and losses may be reduced. Programming of other characteristics, such as, e.g., the magnitude and duration of transients that require correction, the normal AC voltage range over which no backup power is required, and others, may enable a user to optimize system performance and efficiency in an operation.

In various embodiments, a controller 220 and harmonic controller 226, usable within the scope of the present disclosure, can include various types of equipment. For example, some or all of a controller may be implemented as hardware and/or as software code and/or logical instructions that are processed by a computer, a microprocessor, a digital signal processor or other means, or a combination thereof. The logical processes, such as those illustrated in FIG. 7, may run concurrently or sequentially with respect to each other or with respect to other processes, such as measurement processes, UPS output voltage regulation processes and related calculations. A controller may be implemented in mixed-signal circuitry; in circuitry that includes mixed-signal circuitry and/or a microprocessor and/or digital signal processor core and/or a field-programmable-gate-array (FPGA) and/or an application-specific integrated circuit (ASIC); or in circuitry that includes a combination of mixed-signal circuitry and a separate microprocessor, digital signal processor, FPGA or ASIC. Such controllers can be implemented as an integrated circuit or a hybrid device. Additional functions can also be associated with the controller.

It will be understood that various modifications may be made to the inventions described herein without departing from the spirit and scope of the invention. For example, embodied systems could include one or more additional primary or secondary power sources (e.g. a motor-generator set; fuel cell; wind turbine) to supply load power for relatively long periods of time should both the primary and secondary sources be unable to do so. Some system configurations can include a line inductor 248 connected in series with the bypass static switch 222, as illustrated in the partial schematic in FIG. 11; addition of the inductor may enable the controller 220 to perform voltage regulation, in addition to other functions described herein, and as described in the Operation and Performance of a Flywheel-Based Uninterruptible Power Supply (UPS) System, incorporated by reference above.

1. A system for supplying power to a load in communication with a primary power source, the system comprising:
a first maintenance bypass switch between the primary power source and the load;
a secondary power source in communication with the load;
a bypass static switch between the primary power source and the secondary power source;
a second maintenance bypass switch between the secondary power source and the load; and
a controller in communication with the bypass static switch, the first maintenance bypass switch, and the second maintenance bypass switch.

2. The system of claim 1, wherein the bypass static switch comprises a plurality of rectifiers.

3. The system of claim 2, wherein a first rectifier is in communication with the primary power source and wherein a second rectifier is in communication with the secondary power source.

4. The system of claim 2, wherein the plurality of rectifiers comprises a plurality of silicon controlled rectifiers.

5. The system of claim 1, wherein the primary power source comprises a three-phase alternating current utility source, an alternating current generator, a fuel cell, a wind turbine, or combinations thereof.

6. The system of claim 1, further comprising a power conditioner in communication with the secondary power source, wherein the power conditioner comprises:
a first converter in communication with the secondary power source;
a direct current-to-alternating-current converter in communication with the load;
a direct current bus in communication with the first converter and with the direct current-to-alternating-current converter; and
a direct current storage capacitor connected across the direct current bus.

7. The system of claim 6, wherein the primary power source operates at a first frequency and wherein the first converter, the direct current-to-alternating-current converter, the controller, or combinations thereof operates at a second frequency greater than the first frequency.

8. The system of claim 6, further comprising a line filter, an inductor, or combinations thereof in communication with the power conditioner.

9. The system of claim 6, further comprising a battery bank in communication with the direct current bus, wherein the battery bank is configured to provide power to the direct current bus in excess of current able to be supplied by the secondary power source.

10. The system of claim 6, wherein the secondary power source comprises a flywheel-based motor and generator, and wherein the first converter comprises an alternating current-to-direct current converter.

11. The system of claim 6, wherein the secondary power source comprises a plurality of ultracapacitors, and wherein the first converter comprises a direct current-to-direct current converter.

12. The system of claim 6, wherein the power conditioner is configured to receive power from the primary power source via the bypass static switch to charge the direct current storage capacitor.

13. The system of claim 12, wherein the primary power source provides current to the load comprising a fundamental portion having a fundamental frequency and a harmonic portion having a harmonic frequency, and wherein the direct current storage capacitor, the secondary power source, or combinations thereof, are configured to provide reactive power having a current equal and opposite that of the harmonic component, thereby enabling the primary power source to deliver current to the load at the fundamental frequency

14. The system of claim 1, further comprising a three-phase bus positioned between the secondary power source and the load.

15. A method for supplying power to a load in communication with a primary power source, the method comprising:
closing a first maintenance bypass switch positioned between the primary power source and the load to provide power from the primary power source to the load;
opening a second maintenance bypass switch positioned between a secondary power source and the load to disconnect a bypass static switch positioned between the primary power source and the load from the load and to further disconnect the secondary power source from the load;
actuating a controller to transfer current from the primary power source to the secondary power source to charge the secondary power source to a nominal voltage;
actuating the bypass static switch to disconnect the primary power source from the secondary power source;
closing the second maintenance bypass switch to place the secondary power source in communication with the load; and
opening the first maintenance bypass switch to disconnect the primary power source from the load.

16. The method of claim 13, wherein the step of actuating the controller to transfer current from the primary power source comprises transferring a first portion of current generated by the primary power source to the load and a second portion of current generated by the primary power source to the secondary power source.

17. The method of claim 14, wherein the first portion of current generated by the primary power source comprises a fundamental component having a fundamental frequency and harmonic component having a harmonic frequency, the method further comprising actuating the controller to cause the secondary power source to provide reactive power having a current equal and opposite that of the harmonic component, thereby enabling the primary power source to deliver current to the load at the fundamental frequency.

18. The method of claim 15, wherein the secondary power source comprises a bus capacitor and a flywheel-based motor and generator, and wherein actuating the controller to cause the secondary power source to provide reactive power comprises actuating the controller to cause the bus capacitor to supply a first portion of the reactive power insufficient to lower a voltage of the bus capacitor below the nominal voltage and to cause the flywheel-based motor and generator to supply a second portion of the reactive power.

19. A system for supplying power to a load, the system comprising:
a primary power source;
a secondary power source;
a power conditioner comprising a capacitor in communication with the secondary power source;
a static switch between the primary power source and the power conditioner, wherein the static switch is operable to conduct current from the primary power source to the capacitor;
a first maintenance switch between the primary power source and the load, wherein the first maintenance switch is operable to conduct current from the primary power source to the load;
a second maintenance switch between the secondary power source and the load, wherein the second maintenance switch is operable to conduct current from the secondary power source to the load; and
a controller operable to actuate the static switch, the first maintenance switch, and the second maintenance switch,
wherein the primary power source supplies current comprising a fundamental portion having a fundamental frequency and a harmonic portion having a harmonic frequency,
and wherein the capacitor, the secondary power source, or combinations thereof supply reactive power having a current equal and opposite that of the harmonic portion, thereby enabling the primary power source to provide current to the load at the fundamental frequency.

20. The system of claim 19, wherein the primary power source operates at a first frequency, and wherein the power conditioner, the controller, or combinations thereof operates at a second frequency greater than the first frequency.
